(19) United States
(12) Patent Application Publication
(10) Pub. No.: US 2024/0354367 A1
(43) Pub. Date: Oct. 24, 2024

(54) INTERLEAVED DATA LOADING SYSTEM TO OVERLAP COMPUTATION AND DATA STORING FOR OPERATIONS

(71) Applicant: Intel Corporation, Santa Clara, CA (US)

(72) Inventors: Peng ZHAO, Shanghai (CN); Xiao Dong LIN, Shanghai (CN); Zhong CAO, Shanghai (CN); Wei ZHU, Shanghai (CN)

(73) Assignee: Intel Corporation, Santa Clara, CA (US)

(21) Appl. No.: 18/574,968

(22) PCT Filed: Dec. 7, 2021
(86) PCT No.: PCT/CN2021/136030

§ 371 Date: Dec. 28, 2023

(51) Int. Cl. G06F 17/16

(52) U.S. Cl. CPC G06F 17/16

(57) ABSTRACT

Systems, apparatuses and methods include technology that identifies that a computation will be executed based on a plurality of values. The technology determines an order-of-operations associated with the computation and loads the plurality of values in an order determined based on the order-of-operations.

### TECHNICAL FIELD

Embodiments generally relate to a data loading order that is determined based on operations of a computation. In detail, data may be loaded based on an order of operations associated with the data.

### BACKGROUND

Loading data from low-level memory to high-level memory in hierarchy memory systems may be needed for operations such as accumulation. For example, such data may be loaded from global memory to a shared memory in an accelerator, and then the data may be re-used during execution of the operations. In some cases, a memory barrier (e.g., a wait) may be inserted to ensure that the memory loads are visible and loaded before the operations proceed. During the memory barrier, the compute resource is idle resulting in inefficient compute resource usage and longer latency processes.

### BRIEF DESCRIPTION OF THE DRAWINGS

The various advantages of the embodiments will become apparent to one skilled in the art by reading the following specification and appended claims, and by referencing the following drawings, in which:

FIG. 1 is a diagram of an example of a processes for loading data associated with execution of computer code according to an embodiment;

FIG. 2 is a flowchart of an example of a method to load data to execute a multi-step computation according to an embodiment;

FIG. 3 is a diagram of an example of a block loading process according to an embodiment;

FIG. 4 is a flowchart of an example of a method of compressing data according to an embodiment;

FIG. 5 is a flowchart of an example of a method loading and executing computations based on data according to an embodiment;

FIG. 6 is a block diagram of an example of performance-enhanced computing system according to an embodiment;

FIG. 7 is an illustration of an example of a semiconductor apparatus according to an embodiment;

FIG. 8 is a block diagram of an example of a processor according to an embodiment; and

FIG. 9 is a block diagram of an example of a multi-processor based computing system according to an embodiment.

### DESCRIPTION OF EMBODIMENTS

Embodiments as described herein load data in an efficient pattern based on usage during a computation (e.g., general matrix multiply (GEMM)) instead of loading data based solely on a row based/column based order. With data loading approaches as described in embodiments herein, some examples may substantially reduce waiting by compute resources to start the computation nearly immediately after the data is loaded. Furthermore, data storing to a high-level programmable memory may be issued as well. In some embodiments, computation and data storing may be overlapped to avoid unnecessary stalls and enhance efficiency. Thus, embodiments are directed towards a new data loading approach for various multi-step computations (e.g., GEMM) so that data manipulation and computation may be executed in parallel and the number of data loading operations from high level memory (e.g., shared memory) are reduced for computation. For example, some embodiments identify that a computation is to be executed based on a plurality of values, determine an order-of-operations associated with the computation, and load the plurality of values in an order determined based on the order-of-operations so as to reduce latency from memory loading and storing.

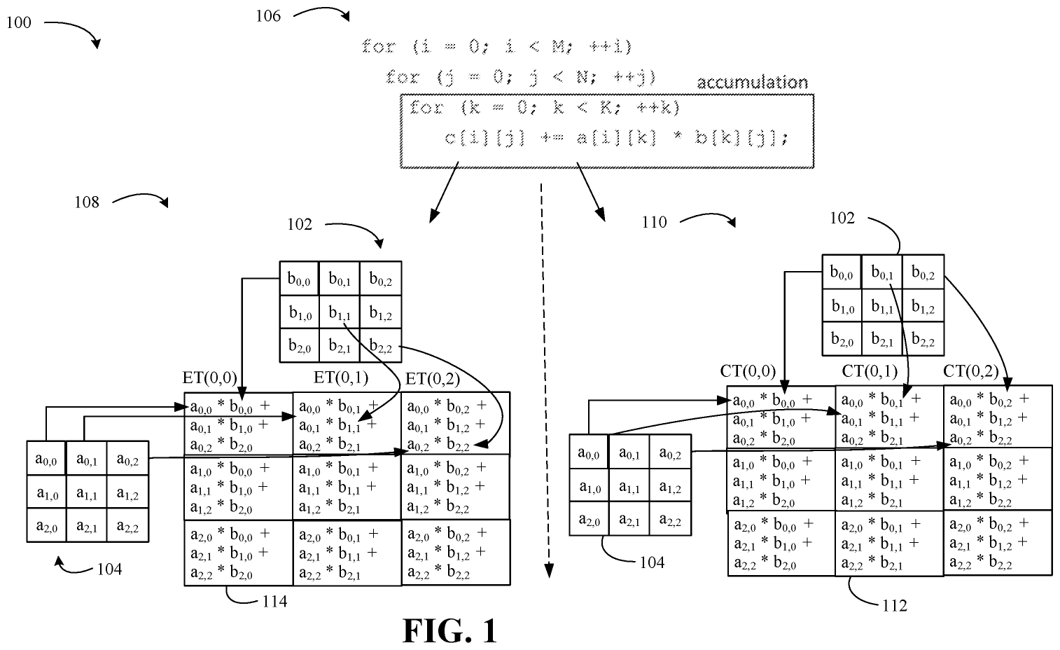

Turning now to FIG. 1, a processes 100 for loading data associated with the execution of computer code 106 is described. Computer code 106 includes three consecutive “for-loops:” 1) a first “for-loop” that includes “i” as a control variable, 2) a second “for-loop” that includes “j” as a control variable and 3) a third “for-loop” that includes “k” as a control variable. The third “for-loop” is an accumulation based on values from the first and second for-loops. The accumulation may be a GEMM computation where C[i][j]==a[i, k]*b[k, j].

In FIG. 1, the accumulation of the computer code 106 may be executed in two different fashions: 1) an enhanced loading and computation operation 108 that executes operations in matrix 114 (e.g., according to embodiments of the present application) and 2) a comparative, conventional loading and computation operation 110 that executes operations in matrix 112.

In the comparative, conventional loading and computation operation 110, a group of conventional threads CT(0, 0), CT (0, 1) and CT (0, 2) will move data from low level storage (e.g., a global memory) to a high level memory (e.g., a shared memory) simultaneously. Thereafter, every thread (e.g., CT(0, 0), CT (0, 1) and CT (0, 2)) waits all data transfers from all other following threads (unillustrated) to be completed from the same threadgroup. After that, computation begins and the data from high level memory (e.g., the shared memory) will be re-loaded and reused. The below steps 1-7 of Table I show the conventional loading and computation operation 110 in greater detail:

TABLE I

1. Load: Thread in a work group loads data from global memory
2. Store: Write data to shared memory
3. Wait: Barrier to wait all data are stored in shared memory
4. Load: Each thread loads the corresponding data
5. Compute: Computation
6. Wait: Barrier to wait all data are consumed
7. Go to Step 1 for next block

In steps 1 and 2, data is first loaded from global memory (e.g., low level memory) and stored to cache (e.g., shared memory or a high level memory). The data may be shared by the threads, so a shared memory is utilized. In step 3, the threads wait until all data is stored so that incorrect data is not accessed. Thus, step 3 may incur performance penalties and increase latency. In step 4, each thread will load data from the shared memory. In step 5, the threads will execute a computation. In step 6, the threads will wait until the data is consumed. The threads in step 7 will then repeat steps 1-6 until all blocks are completed. The sequences of loading (step 1), storing (step 2), waiting (step 3) and loading (step 4) are executed before computation (step 5). That is, computation cannot begin earlier in the process because each thread does not hold the expected data to execute a calculation for the thread. Thus, all threads must wait.

In detail, consider conventional threads CT(0, 0), CT (0, 1) and CT (0, 2) for the conventional loading and computation operation 110. The conventional threads CT(0, 0), CT (0, 1) and CT (0, 2) loads data based on row order. Thus, the thread conventional threads CT(0, 0), CT (0, 1) and CT (0, 2) loads data from row 0 of matrix A 104 and row 0 of matrix B 102. Each of the conventional threads CT(0, 0), CT (0, 1) and CT (0, 2) loads different data. For example, conventional thread CT(0, 0) loads a_{0,0} and b_{0,0}. Conventional thread CT(0, 1) loads a_{0,1} and b_{0,1}. Conventional thread CT(0, 2) loads b_{0,2} and a_{0,2}.

Thus, the data is loaded out of order. That is, the order of operations indicates that multiplication operations are to be executed before the addition operations (e.g., a correct sequence of steps for evaluating a math expression that evaluates in order of parentheses, exponents, multiplication and division from left to right, addition and subtraction from left to right). Thus, it is impossible to execute all of the operations of conventional thread CT(0,1) because conventional thread CT(0,1) loads several values that lack corresponding factors (e.g., multiplier or multiplicand) to complete the operation. For example, the loaded data, a_{0,1} from the matrix A 104 and b_{0,1} from the matrix B 102 are out of order since they are not multiplied together. Rather b_{0,1} is multiplied with a_{0,0} while a_{0,1} is multiplied with b_{1,1}. Similarly, conventional thread CT(0,2) loads data a_{0,2} and b_{0,2} out of order. That is, a_{0,0} is multiplied with b_{0,2} and a_{0,2} is multiplied with b_{2,2}. Thus, both conventional thread CT(0,1) and conventional thread CT(0,2) load data out of order. Each of the conventional threads CT(0,0), CT (0,1), CT(0,2) may not access the data loaded by other threads of the threads CT(0,0), CT (0,1), CT(0,2), or may do so but with increased latency due to barriers and/or waits.

As a consequence, computation cannot begin for several operations leading to latency and idling. For example, only a_{0,0} and b_{0,0} are multiplied together and are loaded by the same thread which is conventional thread CT(0,0). All the conventional threads CT(0,0), CT (0,1), CT(0,2) are thus stalled from executing computations. For example, since it may not be entirely clear which of the conventional threads CT(0,0), CT (0,1), CT(0,2) has all necessary data for a computation, thus all of the threads are placed into a waiting mode for computations to ensure that improper data is not accessed by the conventional threads CT(0,0), CT (0,1), CT(0,2) during computation. The waiting leads to inefficiency from a performance and efficiency viewpoint. In other words, the computations must wait until data for the multiplication operations (e.g., a_{0,0} and b_{1,1} for conventional thread CT(0,1), a_{0,0} and b_{2,2} for conventional thread CT(0,2)) is loaded. The data may be loaded during a later load round by the conventional threads CT(0,1) and CT(0,2). It is worthwhile to note that each of a_{0,0}-a_{2,2} and b_{0,0}-b_{2,2} may be different values.

The enhanced loading and computation operation 108 retrieves data based on order of operations to effectively reduce latency, increase resource utilization and enhance efficiency. That is, the enhanced loading and computation operation 108 retrieves data that will be operated on together (e.g., multiplied together) to execute operations in matrix 114. Doing so may enable more operations to be executed concurrently. For example, according to order-of-operations, multiplication is granted a higher precedence than addition. Thus, the enhanced loading and computation operation 108 analyzes the matrix 114 to retrieve data based on which values will be multiplied together.

For example, the enhanced loading and computation operation 108 determines that a_{0,1} is multiplied with b_{1,1}. Thus, rather than loading b_{0,1}, the enhanced thread ET(0,1) loads b_{1,1} since b_{1,1} is multiplied with a_{0,1}. Furthermore, a_{0,2} is multiplied with b_{2,2}. Thus, rather than loading b_{0,2}, the enhanced thread ET(0,2) loads b_{2,2} since b_{2,2} is multiplied with a_{0,2}. That is, in the enhanced loading and computation operation 108, data is loaded based on the order in which it will be used. As such, three operations (e.g., a_{0,0}*b_{0,0}, a_{0,1}*b_{1,1}, a_{0,2}*b_{2,2}) may be executed since all data for the three operations is retrieved.

Notably, the enhanced loading and computation operation 108 may retrieve the data a_{0,0}, b_{0,m}, a_{0,1}, b_{1,1}, a_{0,2}, b_{2,2} from a low-level (e.g., global memory). Prior to storing the data a_{0,0}, b_{0,m}, a_{0,1}, b_{1,1}, a_{0,2}, b_{2,2} in shared memory, the enhanced loading and computation operation 108 may execute the computations a_{0,0}*b_{0,0}, a_{0,1}*b_{1,1}, a_{0,2}*b_{2,2} and then store the data a_{0,0}, b_{0,0}, a_{0,1}, b_{1,1}, a_{0,2}, b_{2,2} to the shared memory for later re-use in other operations (e.g., round two of a GEMM operation). The data a_{0,0}, b_{0,0}, a_{0,1}, b_{1,1}, a_{0,2}, b_{2,2} may be stored in local registers (e.g., accumulators) to execute the computations a_{0,0}*b_{0,m}, a_{0,1}*b_{1,1}, a_{0,2}*b_{2,2}. Notably, the computations may be executed without waiting and prior to storing the data a_{0,0}, b_{0,m}, a_{0,1}, b_{1,1}, a_{0,2}, b_{2,2} to shared memory to reduce latency and utilize hardware resources that may otherwise remain idle.

Thus, compared to the conventional loading and computation operation 110, the enhanced loading and computation operation 108 operates at a greater efficiency (e.g., 3 computations executed directly after load) to retrieve data based on a computational analysis and execute operations shortly after the data is loaded without waiting. Notably the data (e.g., a_{0,0}, b_{0,m}, a_{0,1}, b_{1,1}, a_{0,2}, b_{2,2}) may be retrieved, the operations may be executed to multiply the data together and may be stored in a shared memory simultaneously. Notably, the data does not need to be stored in the shared memory initially but instead may be stored registers to execute the multiplication operations directly upon retrieval.

Thus, the enhanced loading and computation operation 108 executes parallelism in the M and N directions of the first and second “for-loops” and each thread will calculate and accumulate the results along with K direction for the C output. Thus, some embodiments, include a new data loading order. For example, all the data loaded in one round of loading may operate with each other. Below Equation 1 corresponds to one round of data loading:

$$C \sum i , j = {\sum }_{k}^{K} A [ i , ( i + j + k ) \% K ] * B [ ( i + j + k ) \% K , j ] \qquad Equation 1$$

In equation 1, L is the column of one block of matrix A, and (i,j) represent the thread index of threadgroup. According to the Equation 1, for the first iteration, each thread load A[i, (i+j) % K], B[(i+j) % K,j] in matrix A 104 and matrix B 102. As the scope of (i, j) is 0 to L, the enhanced loading and computation operation 108 will load all elements in in matrix A 104 and matrix B 102 based on the order of operations. In equation 1, K is the column of A and row of B of computer code 106, and (i, j) represents one output point in matrix C as well as thread index. According to the Equation 1, for the first iteration, each thread load A[i, (i+j) % K], B[(i+j) % K, j] (where k=0) in matrix A 104 and matrix B 102. As the scope of (i, j) is 0 to K, the enhanced loading and computation operation 108 will load all elements in matrix A 104 and matrix B 102 based on the order of operations. In some examples, (i, j) represents the index of the matrix in C (output matrix) that one thread needs to compute. The enhanced loading and computation operation 108 may execute computation and store loaded data to shared memory at a same time. In the next iteration, as Equation 1 shows, each thread may obtain A values from the matrix A 104 and B values from the matrix B 102 from a shared memory and executes a local computation.

The below table II illustrates the steps of the enhanced loading and computation operation 108 relative to the steps of the comparative, conventional loading and computation operation 110.

TABLE II

| comparative, conventional loading and | enhanced loading and computation |
|---|---|
| computation operation 110 | operation 108 |
| 1) Load: loads data by natural order | 1) Load: load data based on order of |
| | operations |
| 2) Store: write data to shared memory | 2A) Compute: Use loaded data for a step |
| | computation |
| | 2B) Store: write data to a shared memory |
| 3) Wait: guarantee all data are stored in | 3) Wait: guarantee all data are stored in |
| shared memory | shared memory |
| 4) Load: Each thread reads the | 4) Load: Each thread reads the |
| corresponding data (assume k elements | corresponding data (k − 1 time loading) |
| will be loaded) | |
| 5) Compute: Computation (k time) | 5) Compute: Computation (k − 1 time) |
| 6) Wait: Barrier to wait until all data are | 6) Wait: Barrier to wait until all data are |
| consumed | consumed |
| 7) Go to step 1 for the next k block | 7) go to step 1 for the next k block |

In table 1 above, steps 2A and 2B correspond to the illustrated portion of the enhanced loading and computation operation 108 discussed above. With the enhanced loading and computation operation 108, some embodiments have more opportunities for parallelisms in GEMM to reduce computation time. That is, steps 2A and 2B are executed in parallel or nearly in parallel such that a compute is executed with the loading while bypassing storage of intermediary data (e.g., the values) in the shared memory. In contrast, the comparative, conventional loading and computation operation 110 executes a first computation at 5, while step 2 is purely dedicated to loading resulting in increased waiting and lower efficiency.

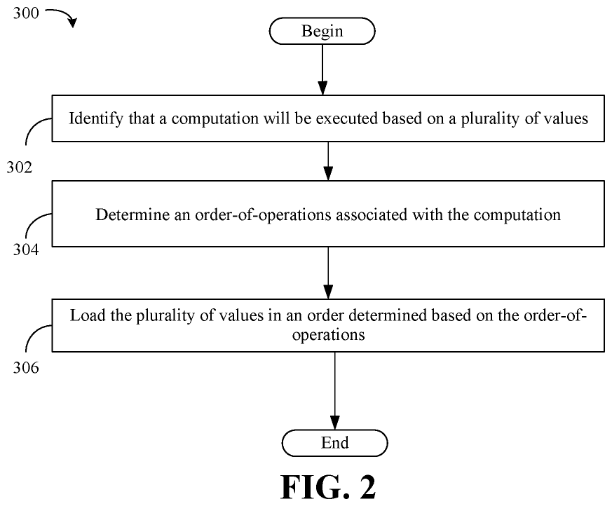

FIG. 2 shows a method 300 to load data to execute a multi-step computation. The method 300 may be readily combinable with any of the embodiments described herein. For example, the method 300 may implement and/or operate in conjunction with one or more aspects of enhanced loading and computation operation 108 (FIG. 1) already discussed. In an embodiment, the method 300 is implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 300 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 302 identifies that a computation will be executed based on a plurality of values. Illustrated processing block 304 determines an order-of-operations associated with the computation. Illustrated processing block 306 loads the plurality of values in an order determined based on the order-of-operations. In some examples, the method 300 includes loading a first subset of the plurality of values prior to a second subset of the plurality of values based on the order-of-operations, and calculates a first value based on the first subset of the plurality of values prior to the second subset of the plurality of values being loaded. In some examples, the method 300 includes loading the first subset of the plurality of values into registers of an accelerator based on the order, computing, with the accelerator, the first value based on the first subset of the plurality of values that are stored in the registers, and storing the first value into a shared memory of the accelerator.

In some examples the method 300 includes identifying that a first value from the plurality of values and a second value from the plurality of values will be multiplied together, and loading the first value and the second value during a same load operation based on the first value and the second value being multiplied together. In some examples, the method 300 includes the computation being executed by an accelerator, and the accelerator is a graphics processing unit, a vision processing unit or an artificial intelligence accelerator. In some embodiments, the computation is a matrix multiplication operation.

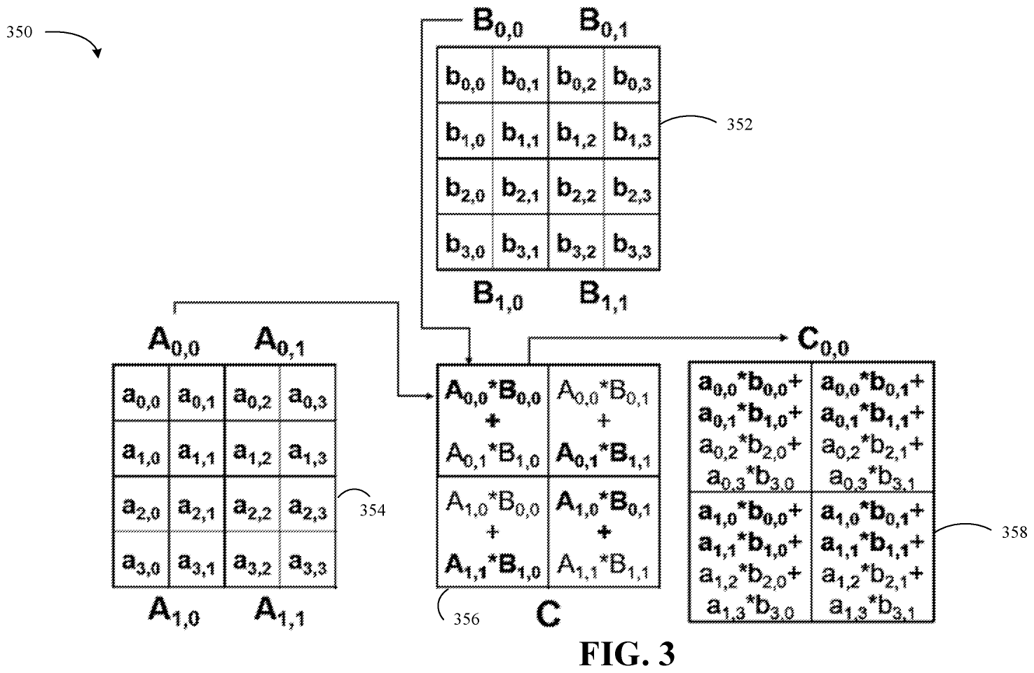

FIG. 3 illustrates an embodiment for a block loading process 350 (e.g., corresponding to step 1 of Table 1), so that more computations may be overlapped upon retrieval followed by a storage to a memory store. Doing so may enable a higher performance ratio. The block loading process 350 may implement and/or operate in conjunction with one or more aspects of enhanced loading and computation operation 108 (FIG. 1) and/or method 300 (FIG. 2) already discussed.

A_{0,0} (which includes matrix a_{0,0}, a_{0,1}, a_{1,0} and a_{1,1}), A_{0,1} (which includes matrix a_{0,2}, a_{1,2}, a_{0,3} and a_{1,3}), A_{1,1} (which includes matrix a_{2,2}, a_{2,3}, a_{3,2} and a_{3,3}) and A_{1,0} (which includes matrix a_{2,0}, a_{2,1}, a_{3,0} and a_{3,1}) may be loaded from matrix A 354 and stored in registers to execute operations of matrix C 356. B_{0,0} (which includes matrix b_{0,0}, b_{0,1}, b_{1,0} and b_{1,1}), B_{1,1} (which includes matrix b_{2,2}, b_{2,3}, b_{3,2} and b_{3,3}), B_{1,0} (which includes matrix b_{2,0}, b_{2,1}, b_{3,0} and b_{3,1}) and B_{0,1} (which includes b_{0,2}, b_{1,2}, b_{0,3} and b_{1,3}) from matrix B 352 may be loaded from matrix B 354 and stored in registers to execute the operations matrix C 356. In this example, a 2×2 division is used, but the division may be any value (e.g., 3×3 or 4×4) based on different hardware and implementation. A specific representation of the values from matrix A 354 and matrix B 352 are illustrated in the detailed representation of matrix C 358. The number of elements in a block may be dynamic based on the hardware architecture and algorithms implementation. Table III illustrates the operations of the block loading process 350.

TABLE III

| | |
|---|---|
| 1) | Load: load an amount of data, kk, according to order of operations. Each thread |
| | in each step may load more than 1 element (e.g., 2 × 2 square matrix so that kk is |
| | defined as 4), so multiple elements are loaded per time from matrix A 354 and |
| | matrix B 352 separately. |
| 2) | A) Store: write all data to shared memory. In this example, “all” means all loaded |
| | data for one round of computation rather than all data in matrix A 354 and matrix |
| | B 352; and |
| | B) compute: use loaded data for kk step computation |
| 3) | Wait: guarantee all data are stored in shared memory |
| 4) | Load: Each thread reads the corresponding data (e.g., k − kk time loading). For |
| | example, there may be a total of k elements that will be loaded and computed in |
| | each step, but in one step data is already stored in step 2A. Thus, only k − 1 times |
| | loads are remaining for loading from shared memory and computations again. In |
| | this example, because the embodiment extends one element load and |
| | computation to kk(=4), the remaining number is k − kk. |
| 5) | Compute: Computation k − kk time |
| 6) | Wait: barrier to wait all data are consumed |
| 7) | Go to step 1 for next k block |

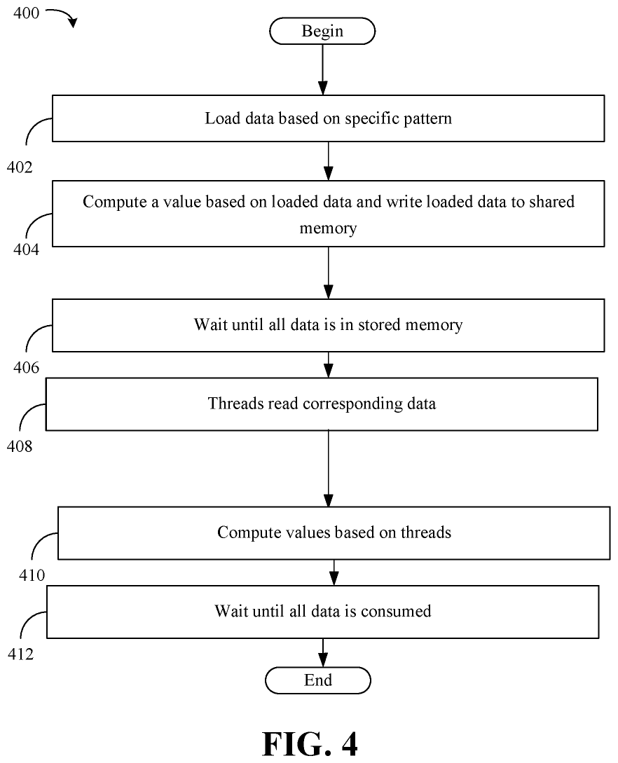

FIG. 4 shows a method 400 of compressing data. The method 400 may be readily combinable with any of the embodiments described herein. For example, the method 400 may implement and/or operate in conjunction with one or more aspects of the enhanced loading and computation operation 108 (FIG. 1), method 300 (FIG. 2) and/or block loading process 350 (FIG. 3). More particularly, the method 400 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated processing block 402 loads data based on a specific pattern (e.g., an order-of-operations). Illustrated processing block 404 computes a value based on loaded data and writes the loaded data to shared memory. Illustrated processing block 406 waits until all data is in stored memory. Illustrated processing block 408 includes threads reading corresponding data. Illustrated processing block 410 computes values based on the threads. Illustrated processing block 412 waits until all data is consumed.

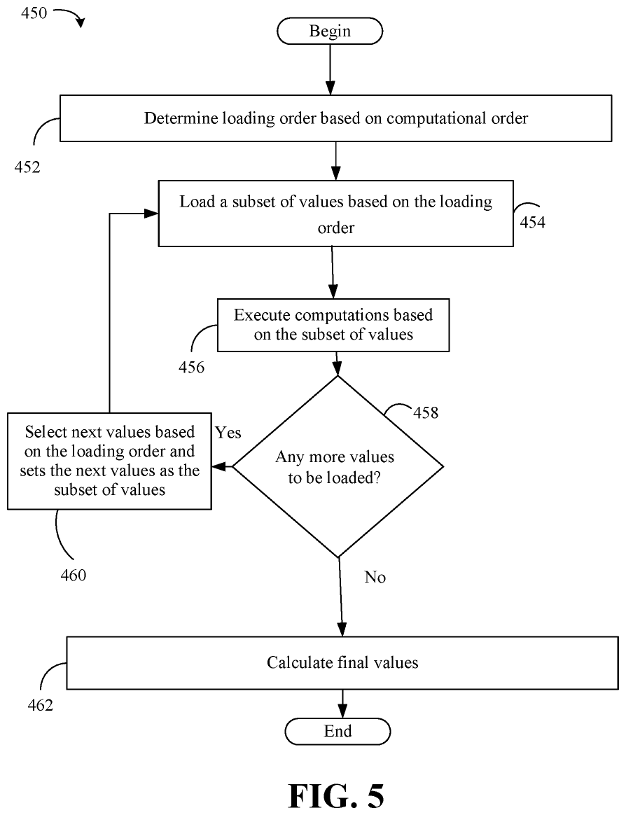

FIG. 5 shows a method 450 of loading and executing computations based on data. The method 450 may be readily combinable with any of the embodiments described herein. For example, the method 450 may implement and/or operate in conjunction with one or more aspects of enhanced loading and computation operation 108 (FIG. 1), method 300 (FIG. 2), block loading process 350 (FIG. 3) and/or method 400 (FIG. 4). More particularly, the method 450 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated processing block 452 determines a loading order based on computational order. Illustrated processing block 454 loads a subset of values based on the loading order. Illustrated processing block 456 executes computations based on the subset of values. Illustrated processing block 458 determines if more values are to be loaded. If so, illustrated processing block 460 selects next values based on the loading order and sets the next values as the subset of values. Otherwise, illustrated processing block 462 calculate final values.

Each respective thread loads a part of data that happens to be the data to satisfy several steps of computation for an output of the respective thread. Thus, the calculation and data may be executed simultaneously.

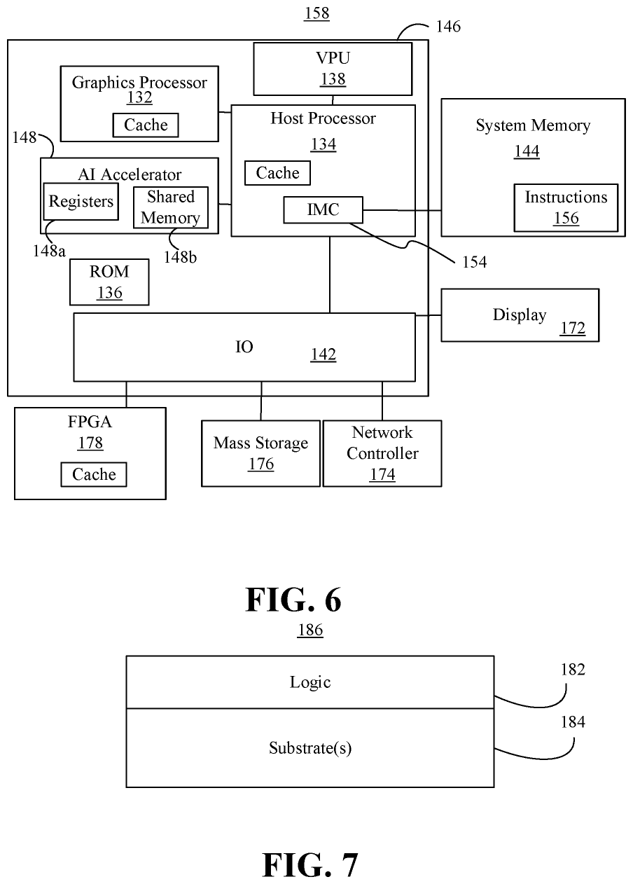

Turning now to FIG. 6, a performance enhanced computing system 158 is shown. The computing system 158 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), etc., or any combination thereof. In the illustrated example, the computing system 158 includes a host processor 134 (e.g., CPU) having an integrated memory controller (IMC) 154 that is coupled to a system memory 144.

The illustrated computing system 158 also includes an input output (IO) module 142 implemented together with the host processor 134, a graphics processor 132 (e.g., GPU), ROM 136, and AI accelerator 148 on a semiconductor die 146 as a system on chip (SoC). The illustrated IO module 142 communicates with, for example, a display 172 (e.g., touch screen, liquid crystal display/LCD, light emitting diode/LED display), a network controller 174 (e.g., wired and/or wireless), FPGA 178 and mass storage 176 (e.g., hard disk drive/HDD, optical disk, solid state drive/SSD, flash memory). Furthermore, the SoC 146 may further include processors (not shown) and/or the AI accelerator 148 dedicated to artificial intelligence (AI) and/or neural network (NN) processing. For example, the system SoC 146 may include a vision processing unit (VPU) 138 and/or other AI/NN-specific processors such as AI accelerator 148, etc.

The graphics processor 132 and/or the host processor 134 may execute instructions 156 retrieved from the system memory 144 (e.g., a dynamic random-access memory) and/or the mass storage 176 to implement aspects as described herein. In some examples, graphics processor 132, VPU 138 and/or AI accelerator 148 contains a sizeable “global memory” for data storage, so input data will be transferred to the global memory of the graphics processor 132, VPU 138 and/or AI accelerator 148 from system memory 144 before the computation executes. The data is then transferred from the “global memory” to a shared memory and/or register(s) of the graphics processor 132, VPU 138 and/or AI accelerator 148. In some examples, the graphics processor 132, VPU 138 and/or AI accelerator 148 do not have global memory but contain a shared memory and/or registers. For example, the AI accelerator 148 (e.g., a Field-Programmable Gate Array (FPGA), Application-Specific Integrated Circuit (ASIC), Tensor Processing Unit (TPU), etc.) may execute a computation. The computing system 158 may identify that the computation is to be executed based on a plurality of values, determine an order-of-operations associated with the computation, and load the plurality of values to the AI accelerator 148 in an order determined based on the order-of-operations. For example, the computing system 158 may load to the AI accelerator 148, a first subset of the plurality of values prior to a second subset of the plurality of values based on the order-of-operations, and calculates a first value based on the first subset of the plurality of values prior to the second subset of the plurality of values being loaded. The AI accelerator 148 loads the first subset of the plurality of values into registers 148a of the AI accelerator 148 based on the order, computes, with the AI accelerator 148, the first value based on the first subset of the plurality of values that are stored in the registers 148a. The AI accelerator 148 stores the first value into a shared memory 148b of the AI accelerator 148. The AI accelerator 148 identifies that a first value from the plurality of values and a second value from the plurality of values will be multiplied together, and loads the first value and the second value during a same load operation based on the first value and the second value being multiplied together. As discussed, the computation is executed by the AI accelerator 148. In some embodiments, the graphics processor 132 and/or the VPU 138 may be readily substituted for the AI accelerator 148. The computing system 158 may implement one or more aspects of enhanced loading and computation operation 108 (FIG. 1), method 300 (FIG. 2), block loading process 350 (FIG. 3), method 400 (FIG. 4), and/or method 450 (FIG. 5) already discussed. The illustrated computing system 158 is therefore considered to be performance-enhanced at least to the extent that it enables the computing system 158 to intelligently load data and execute computations with reduced latency.

FIG. 7 shows a semiconductor apparatus 186 (e.g., chip, die, package). The illustrated apparatus 186 includes one or more substrates 184 (e.g., silicon, sapphire, gallium arsenide) and logic 182 (e.g., transistor array and other integrated circuit/IC components) coupled to the substrate(s) 184. In an embodiment, the apparatus 186 is operated in an application development stage and the logic 182 performs one or more aspects of the embodiments described herein, for example, one or more aspects of the enhanced loading and computation operation 108 (FIG. 1), method 300 (FIG. 2), block loading process 350 (FIG. 3), method 400 (FIG. 4), and/or method 450 (FIG. 5) already discussed. The logic 182 may be implemented at least partly in configurable logic or fixed-functionality hardware logic. In one example, the logic 182 includes transistor channel regions that are positioned (e.g., embedded) within the substrate(s) 184. Thus, the interface between the logic 182 and the substrate(s) 184 may not be an abrupt junction. The logic 182 may also be considered to include an epitaxial layer that is grown on an initial wafer of the substrate(s) 184.

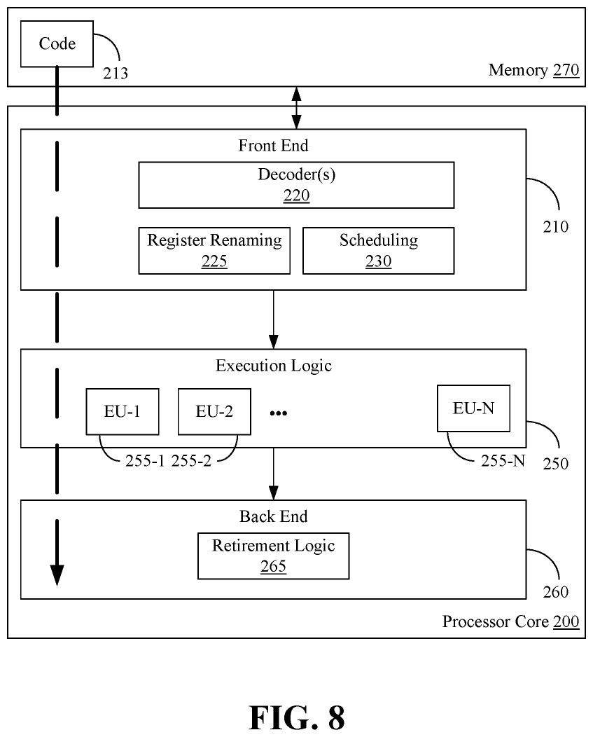

FIG. 8 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 8, a processing element may alternatively include more than one of the processor core 200 illustrated in FIG. 8. The processor core 200 may be a single-threaded core or, for at least one embodiment, the processor core 200 may be multithreaded in that it may include more than one hardware thread context (or “logical processor”) per core.

FIG. 8 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the embodiments such as, for example, loading and computation operation 108 (FIG. 1), method 300 (FIG. 2), block loading process 350 (FIG. 3), method 400 (FIG. 4), and/or method 450 (FIG. 5) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 8, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

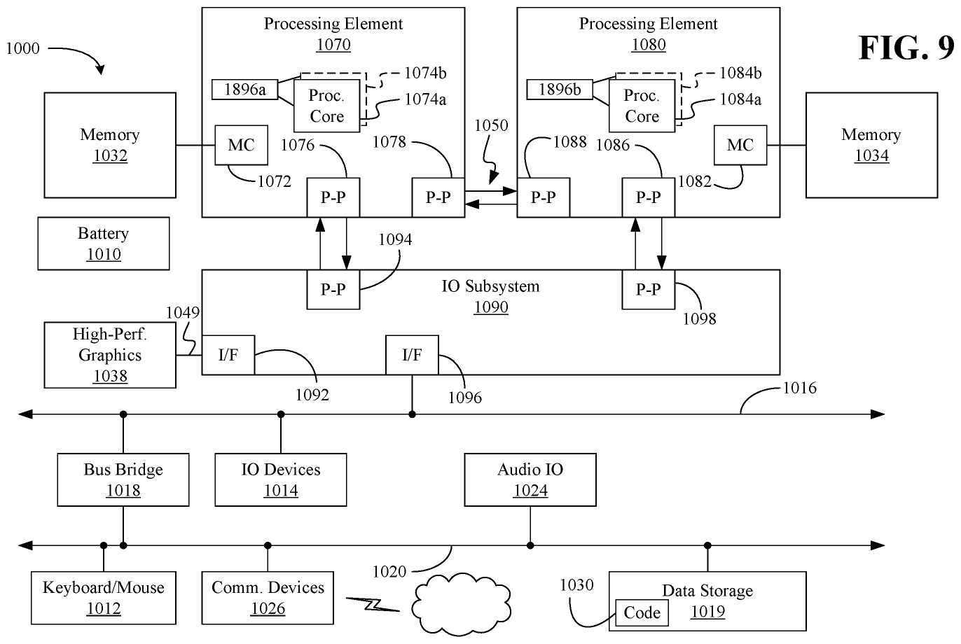

Referring now to FIG. 9, shown is a block diagram of a computing system 1000 embodiment in accordance with an embodiment. Shown in FIG. 9 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 9 may be implemented as a multi-drop bus rather than point-to-point interconnect.

As shown in FIG. 9, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 8.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 9, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 9, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 9, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement one or more aspects of enhanced loading and computation operation 108 (FIG. 1), method 300 (FIG. 2), block loading process 350 (FIG. 3), method 400 (FIG. 4), and/or method 450 (FIG. 5) already discussed. Further, an audio I/O 1024 may be coupled to second bus 1020 and a battery 1010 may supply power to the computing system 1000.

Note that other embodiments are contemplated. For example, instead of the point-to-point architecture of FIG. 9, a system may implement a multi-drop bus or another such communication topology. Also, the elements of FIG. 9 may alternatively be partitioned using more or fewer integrated chips than shown in FIG. 9.

### Additional Notes and Examples

Example 1 includes a computing system comprising an accelerator to execute a computation, a processor, and a memory coupled to the processor and the accelerator, the memory including a set of executable program instructions, which when executed by one or more of the processor or the accelerator, cause the computing system to identify that the computation is to be executed based on a plurality of values, determine an order-of-operations associated with the computation, and load the plurality of values in an order determined based on the order-of-operations.

Example 2 includes the computing system of Example 1, wherein the executable program instructions, when executed, cause the computing system to load a first subset of the plurality of values prior to a second subset of the plurality of values based on the order-of-operations, and calculate a first value based on the first subset of the plurality of values prior to the second subset of the plurality of values being loaded.

Example 3 includes the computing system of Example 2, wherein the executable program instructions, when executed, cause the computing system to load the first subset of the plurality of values into registers of the accelerator based on the order, compute the first value based on the first subset of the plurality of values that are stored in the registers, and store the first value into a shared memory of the accelerator.

Example 4 includes the computing system of any one of Examples 1 to 3, wherein the executable program instructions, when executed, cause the computing system to identify that a first value from the plurality of values and a second value from the plurality of values are to be multiplied together, and load the first value and the second value during a same load operation based on the first value and the second value being multiplied together.

Example 5 includes the computing system of any one of Examples 1 to 4, wherein the accelerator is a graphics processing unit, a vision processing unit or an artificial intelligence accelerator.

Example 6 includes the computing system of any one of Examples 1 to 5, wherein the computation is a matrix multiplication operation.

Example 7 includes a semiconductor apparatus comprising one or more substrates, and logic coupled to the one or more substrates, wherein the logic is implemented in one or more of configurable or fixed-functionality hardware, the logic to identify that a computation is to be executed based on a plurality of values, determine an order-of-operations associated with the computation, and load the plurality of values in an order determined based on the order-of-operations.

Example 8 includes the apparatus of Example 7, wherein the logic coupled to the one or more substrates is to load a first subset of the plurality of values prior to a second subset of the plurality of values based on the order-of-operations, and calculate a first value based on the first subset of the plurality of values prior to the second subset of the plurality of values being loaded.

Example 9 includes the apparatus of Example 8, wherein the logic coupled to the one or more substrates is to load the first subset of the plurality of values into registers of an accelerator based on the order, compute, with the accelerator, the first value based on the first subset of the plurality of values that are stored in the registers, and store the first value into a shared memory of the accelerator.

Example 10 includes the apparatus of any one of Examples 7 to 9, wherein the logic coupled to the one or more substrates is to identify that a first value from the plurality of values and a second value from the plurality of values are to be multiplied together, and load the first value and the second value during a same load operation based on the first value and the second value being multiplied together.

Example 11 includes the apparatus of any one of Examples 7 to 10, wherein the computation is to be executed by an accelerator, and the accelerator is a graphics processing unit, a vision processing unit or an artificial intelligence accelerator.

Example 12 includes the apparatus of any one of Examples 7 to 11, wherein the computation is a matrix multiplication operation.

Example 13 includes the apparatus of any one of Examples 7 to 12, wherein the logic coupled to the one or more substrates includes transistor channel regions that are positioned within the one or more substrates.

Example 14 includes at least one computer readable storage medium comprising a set of executable program instructions, which when executed by a computing system, cause the computing system to identify that a computation is to be executed based on a plurality of values, determine an order-of-operations associated with the computation, and load the plurality of values in an order determined based on the order-of-operations.

Example 15 includes the at least one computer readable storage medium of Example 14, wherein the instructions, when executed, further cause the computing system to load a first subset of the plurality of values prior to a second subset of the plurality of values based on the order-of-operations, and calculate a first value based on the first subset of the plurality of values prior to the second subset of the plurality of values being loaded.

Example 16 includes the at least one computer readable storage medium of Example 15, wherein the instructions, when executed, further cause the computing system to load the first subset of the plurality of values into registers of an accelerator based on the order, compute, with the accelerator, the first value based on the first subset of the plurality of values that are stored in the registers, and store the first value into a shared memory of the accelerator.

Example 17 includes the at least one computer readable storage medium of any one of Examples 14 to 16, wherein the instructions, when executed, further cause the computing system to identify that a first value from the plurality of values and a second value from the plurality of values are to be multiplied together, and load the first value and the second value during a same load operation based on the first value and the second value being multiplied together.

Example 18 includes the at least one computer readable storage medium of any one of Examples 14 to 17, wherein the computation is to be executed by an accelerator, and the accelerator is a graphics processing unit, a vision processing unit or an artificial intelligence accelerator.

Example 19 includes the at least one computer readable storage medium of any one of Examples 14 to 18, wherein the computation is a matrix multiplication operation.

Example 20 includes a method comprising identifying that a computation will be executed based on a plurality of values, determining an order-of-operations associated with the computation, and loading the plurality of values in an order determined based on the order-of-operations.

Example 21 includes the method of Example 20, further comprising loading a first subset of the plurality of values prior to a second subset of the plurality of values based on the order-of-operations, and calculating a first value based on the first subset of the plurality of values prior to the second subset of the plurality of values being loaded.

Example 22 includes the method of Example 21, further comprising loading the first subset of the plurality of values into registers of an accelerator based on the order, computing, with the accelerator, the first value based on the first subset of the plurality of values that are stored in the registers, and storing the first value into a shared memory of the accelerator.

Example 23 includes the method of any one of Examples 20 to 22, further comprising identifying that a first value from the plurality of values and a second value from the plurality of values will be multiplied together, and loading the first value and the second value during a same load operation based on the first value and the second value being multiplied together.

Example 24 includes the method of any one of Examples 20 to 23, wherein the computation is executed by an accelerator, and the accelerator is a graphics processing unit, a vision processing unit or an artificial intelligence accelerator.

Example 25 includes the method of any one of Examples 20 to 24, wherein the computation is a matrix multiplication operation.

Example 26 includes a semiconductor apparatus comprising means for identifying that a computation will be executed based on a plurality of values, means for determining an order-of-operations associated with the computation, and means for loading the plurality of values in an order determined based on the order-of-operations.

Example 27 includes the apparatus of Example 26, further comprising means for loading a first subset of the plurality of values prior to a second subset of the plurality of values based on the order-of-operations, and means for calculating a first value based on the first subset of the plurality of values prior to the second subset of the plurality of values being loaded.

Example 28 includes the apparatus of Example 27, further comprising means for loading the first subset of the plurality of values into registers of an accelerator based on the order, means for computing, with the accelerator, the first value based on the first subset of the plurality of values that are stored in the registers, and means for storing the first value into a shared memory of the accelerator.

Example 29 includes the apparatus of any one of Examples 26 to 28, further comprising means for identifying that a first value from the plurality of values and a second value from the plurality of values will be multiplied together, and means for loading the first value and the second value during a same load operation based on the first value and the second value being multiplied together.

Example 30 includes the apparatus of any one of Examples 26 to 29, wherein the computation is executed by an accelerator, and the accelerator is a graphics processing unit, a vision processing unit or an artificial intelligence accelerator.

Example 31 includes the apparatus of any one of Examples 26 to 30, wherein the computation is a matrix multiplication operation.

Thus, technology described herein may provide for an enhanced system that load data based on computational order. Latency and waiting may be reduced by doing so.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
an accelerator to execute a computation;
a processor; and
a memory coupled to the processor and the accelerator, the memory including a set of executable program instructions, which when executed by one or more of the processor or the accelerator, cause the computing system to:
identify that the computation is to be executed based on a plurality of values,
determine an order-of-operations associated with the computation, and
load the plurality of values in an order determined based on the order-of-operations.

2. The computing system of claim 1, wherein the executable program instructions, when executed, cause the computing system to:
load a first subset of the plurality of values prior to a second subset of the plurality of values based on the order-of-operations, and
calculate a first value based on the first subset of the plurality of values prior to the second subset of the plurality of values being loaded.

3. The computing system of claim 2, wherein the executable program instructions, when executed, cause the computing system to:
load the first subset of the plurality of values into registers of the accelerator based on the order,
compute the first value based on the first subset of the plurality of values that are stored in the registers, and
store the first value into a shared memory of the accelerator.

4. The computing system of claim 1, wherein the executable program instructions, when executed, cause the computing system to:
identify that a first value from the plurality of values and a second value from the plurality of values are to be multiplied together, and
load the first value and the second value during a same load operation based on the first value and the second value being multiplied together.

5. The computing system of claim 1, wherein the accelerator is a graphics processing unit, a vision processing unit or an artificial intelligence accelerator.

6. The computing system of claim 1, wherein the computation is a matrix multiplication operation.

7. A semiconductor apparatus comprising:
one or more substrates; and
logic coupled to the one or more substrates, wherein the logic is implemented in one or more of configurable or fixed-functionality hardware, the logic to:
identify that a computation is to be executed based on a plurality of values;
determine an order-of-operations associated with the computation; and
load the plurality of values in an order determined based on the order-of-operations.

8. The apparatus of claim 7, wherein the logic coupled to the one or more substrates is to:
load a first subset of the plurality of values prior to a second subset of the plurality of values based on the order-of-operations; and
calculate a first value based on the first subset of the plurality of values prior to the second subset of the plurality of values being loaded.

9. The apparatus of claim 8, wherein the logic coupled to the one or more substrates is to:
load the first subset of the plurality of values into registers of an accelerator based on the order;
compute, with the accelerator, the first value based on the first subset of the plurality of values that are stored in the registers; and
store the first value into a shared memory of the accelerator.

10. The apparatus of claim 7, wherein the logic coupled to the one or more substrates is to:
identify that a first value from the plurality of values and a second value from the plurality of values are to be multiplied together; and
load the first value and the second value during a same load operation based on the first value and the second value being multiplied together.

11. The apparatus of claim 7, wherein:
the computation is to be executed by an accelerator; and
the accelerator is a graphics processing unit, a vision processing unit or an artificial intelligence accelerator.

12. The apparatus of claim 7, wherein the computation is a matrix multiplication operation.

13. The apparatus of claim 7, wherein the logic coupled to the one or more substrates includes transistor channel regions that are positioned within the one or more substrates.

14. At least one computer readable storage medium comprising a set of executable program instructions, which when executed by a computing system, cause the computing system to:
identify that a computation is to be executed based on a plurality of values;
determine an order-of-operations associated with the computation; and
load the plurality of values in an order determined based on the order-of-operations.

15. The at least one computer readable storage medium of claim 14, wherein the instructions, when executed, further cause the computing system to:
load a first subset of the plurality of values prior to a second subset of the plurality of values based on the order-of-operations; and
calculate a first value based on the first subset of the plurality of values prior to the second subset of the plurality of values being loaded.

16. The at least one computer readable storage medium of claim 15, wherein the instructions, when executed, further cause the computing system to:
load the first subset of the plurality of values into registers of an accelerator based on the order;
compute, with the accelerator, the first value based on the first subset of the plurality of values that are stored in the registers; and
store the first value into a shared memory of the accelerator.

17. The at least one computer readable storage medium of claim 14, wherein the instructions, when executed, further cause the computing system to:
identify that a first value from the plurality of values and a second value from the plurality of values are to be multiplied together; and
load the first value and the second value during a same load operation based on the first value and the second value being multiplied together.

18. The at least one computer readable storage medium of claim 14, wherein:
the computation is to be executed by an accelerator; and
the accelerator is a graphics processing unit, a vision processing unit or an artificial intelligence accelerator.

19. The at least one computer readable storage medium of claim 14, wherein the computation is a matrix multiplication operation.

20. A method comprising:
identifying that a computation will be executed based on a plurality of values;
determining an order-of-operations associated with the computation; and
loading the plurality of values in an order determined based on the order-of-operations.

21. The method of claim 20, further comprising:
loading a first subset of the plurality of values prior to a second subset of the plurality of values based on the order-of-operations; and
calculating a first value based on the first subset of the plurality of values prior to the second subset of the plurality of values being loaded.

22. The method of claim 21, further comprising:
loading the first subset of the plurality of values into registers of an accelerator based on the order;
computing, with the accelerator, the first value based on the first subset of the plurality of values that are stored in the registers; and
storing the first value into a shared memory of the accelerator.

23. The method of claim 20, further comprising:
identifying that a first value from the plurality of values and a second value from the plurality of values will be multiplied together; and
loading the first value and the second value during a same load operation based on the first value and the second value being multiplied together.

24. The method of claim 20, wherein:
the computation is executed by an accelerator; and
the accelerator is a graphics processing unit, a vision processing unit or an artificial intelligence accelerator.

25. The method of claim 20, wherein the computation is a matrix multiplication operation.
